(19) United States
(12) Patent Application Publication
(10) Pub. No.: US 2013/0156892 A1
(43) Pub. Date: Jun. 20, 2013

(54) EDIBLE COMPOSITIONS AND METHODS OF MANUFACTURING EDIBLE COMPOSITONS

(71) Applicant: Frederick Wade Mussawir-Key, East Grinstead (GB)

(72) Inventor: Frederick Wade Mussawir-Key, East Grinstead (GB)

(73) Assignee: ST. GILES FOODS LIMITED, East Grinstead, West Sussex (GB)

(21) Appl. No.: 13/702,032

(22) PCT Filed: May 4, 2011
(86) PCT No.: PCT/GB2011/000676

§ 371 Date: Feb. 12, 2013

(30) Foreign Application Priority Data
May 5, 2010 (GB) 1007500.0
May 20, 2010 (GB) 1008449.9
Jul. 16, 2010 (GB) 1011961.8
Sep. 8, 2010 (GB) 1014956.5

(51) Int. Cl. A23L 1/24

(52) U.S. Cl. CPC A23L 1/243
USPC 426/72; 426/589; 426/541

(57) ABSTRACT

There is provided edible compositions and methods of manufacturing edible compositions comprising a base comprising fruit and/or vegetable matter with a fibrous matrix and a water immiscible nutritional supplement held within, including on the surface of the fibrous matrix. The nutritional supplement can comprise nutritional, functional and/or nutraceutical oils such as unsaturated or partly unsaturated fatty acids from both animal, including fish, plant and algal sources. The composition may also comprise solid nutritional supplements. The fibrous matrix helps to both retain the nutritional supplement to prevent separation of the supplement within the base and further helps to organoleptically mask the presence of the nutritional supplements in the composition.

The present invention relates to edible compositions and methods of manufacturing edible compositions, in particular compositions based on fruit and/or vegetable matter.

According to the present invention, there is provided an edible composition having a base comprising fruit and/or vegetable matter with a fibrous matrix and a water immiscible nutritional supplement held within the fibrous matrix.

The term “nutritional supplement” is used in the context of the present invention to mean one or more substances, which can be naturally occurring or synthetic, that provide nutritional and/or health benefits, and/or therapeutic benefits (such as essential fatty acids, oils or oil-like substances of particular nutritional or therapeutic value, vitamins, minerals and salts, minerals/salt compounds) and that are missing or are otherwise not present or consumed in sufficient quantities in the diet of certain persons or animals. Such supplements are typically not classified as regulated pharmaceuticals, but the provision of nutritional supplements that are regulated pharmaceuticals is within the scope of the present invention. In the present specification the term nutritional supplements includes substances that may otherwise be termed functional supplements, dietetic supplements and nutraceutical supplements.

The term “water immiscible” is used in the context of the present invention to mean the general inability to form a solution with water, particularly at temperatures up to 30° C., but up to 60° C. in certain embodiments, and includes liquid/liquid immiscibility and immiscibility between other phases, such as solid/liquid.

The fibrous matrix may comprise dietary fibre and may comprise natural insoluble fibres from fruit and/or vegetables. The fibrous matrix may be plant-derived and may comprise primarily cellulose, but may comprise one or more of hemicellulose and/or lignin. Alternatively or in addition the fibrous matrix may comprise soluble fibres such as pectin and/or gum and/or other non-starch polysaccharides, particularly oligosaccharides.

The base is preferably aqueous. The base may comprise matter suspended in an aqueous liquid. The aqueous liquid may comprise the juice of the fruit(s) and/or vegetable(s). The aqueous liquid may comprise the juice of one or more different fruit(s) and/or vegetable(s). The matter may comprise one or more of pulped, comminuted, mashed, blended, crushed, mushed, shredded, natural state, peeled, cored, de-seeded, pre-pureed and/or grated fruit(s) and/or vegetable(s). The base may comprise the pulp of one or more fruit(s) and/or vegetable(s) mixed or suspended in the aqueous liquid. One or more of the fruit(s) and/or vegetable(s) may be fresh, raw, chemically preserved, such as by SO₂, pasteurised, sterilised, canned, frozen, chilled, dried, dehydrated or otherwise preserved. One or more of the fruit/vegetables may be heat treated prior to being peeled, such as by the hot pack/break process, to reduce or deactivate enzyme activity.

The base may comprise additives such as one or more of water, antioxidants (such as Vitamin E (tocopherol), ascorbyl palmitate, BHA, BHT, BHQ, ascorbic acid and/or its salts), preservatives, flavourings, seasonings, colourants, sweeteners, acidity regulators, thickeners, stabilisers, chelating agent, vitamins, Vitamin C, vinegars, acidity regulators, salt, sugar (raw, refined and/or partly refined), fructose, fructose syrup, inulin, oligofructose, polysaccharides, glucose, molasses, fruit juice concentrates and other permitted additives. The base may be concentrated, such as by evaporation or otherwise, to reduce the natural water content.

The base may comprise more than 0.5 g of fibrous matrix per 100 g and in certain embodiments comprises more than 3 g of fibrous matrix per 100 g and in others between 3 g and 5 g per 100 g. The base may comprise 0.15 g to 2.5 g of fibrous matrix per 100 g and may be 0.4 g to 1.7 g of fibrous matrix per 100 g.

The composition is preferably liquid or semi-liquid, although it may be non-liquid in certain embodiments.

The nutritional supplement may comprise oil, such as one or more of a nutritional, functional and/or nutraceutical oil. The nutritional supplement may be comprised wholly or substantially wholly of oil or may be primarily of oil to be generally or mainly immiscible in the aqueous base. The nutritional supplement may be oil soluble and/or oil solublisable.

In such embodiments, droplets of the nutritional supplement may be physically retained in the fibrous matrix of the matter. This has a number of advantages. It enables the generally or mainly immiscible nutritional supplement to be held suspended/retained within the composition with relatively little movement of the supplement, thus preventing or at least significantly hindering separation and the natural tendency for the nutritional supplement to float to the surface of the liquid of the base. This provides the compositions with good storage properties and shelf lives. It also enables the nutritional supplement to be dispersed within the base without the need to reduce the droplet size to such an extent as to form an emulsion, which tends to introduce a milkiness (turbidity) or cloudiness to the composition, often considered unattractive to consumers. It also acts to mask the presence of the nutritional supplement within the composition, thus masking or partly masking any unattractive qualities of certain nutritional supplements, such as adverse taste, visual and/or smell qualities.

Typically, the nutritional supplement is in the form of droplets, with the vast majority of droplets of nutritional supplement having an external diameter of less than 30 microns, with most (between 85% and 90%) having a droplet size of between 5 and 10 microns.

The nutritional supplement may comprise one or more oils and/or oily substances containing and preferably rich in nutritional, functional and/or nutraceutical agents such as one or more of unsaturated or partly unsaturated fatty acids, in particular polyunsaturated fatty acids, Omega 3 fatty acids including ALA (alpha linoleic acid) and DHA (docosahexaenoic acid), conjugated linoleic acid (CLA) and its isomers, partly saturated fatty acids, fatty acid esters, oils and/or oily substances derived from one or more of plant sources (such as linseed, hemp, rapeseed, tall, sesame, flax, chia, safflower, wood oil CLA, pine oil CLA, rice, wheat, soya (and soya germ), other seeds, animal sources (such as fish, krill) or other organism sources (such as algae, micro-algae), L-carnitine.

The oils and oily substances, and particularly those with relatively pungent or otherwise undesirable odours, tastes, colours and the like such as those sourced from marine organisms (such as fish, krill and marine algae), may be refined, fractionated, deflavourised and/or deodorised.

In certain embodiments the nutritional supplement comprises one or more substances from both aquatic/marine sources such as fish, krill, algal and non-aquatic/marine sources such as seeds, whereby the odour and taste of the aquatic/marine substance(s) are diluted.

Such nutritional supplements may comprise between 0.005% and 5% by weight of the composition. The nutritional supplements may comprise between 0.01% and 5%, and in other embodiments between 0.1% and 3% by weight of the composition. In certain embodiments the nutritional supplement constitutes between 0.05% and 1% by weight of the composition. In certain embodiments the supplement constitutes between 0.1% and 0.5% by weight of the composition.

The nutritional supplement may comprise one or more of phytosterols (including their esters), phytostanols (including their esters), mineral supplements, organomineral supplements, organometal supplements, antioxidants and suchlike, which are preferably provided in oil and/or oily substances that may be naturally rich therein. The nutritional supplements may be in their natural form, modified and/or synthetic form.

The composition may comprise one or more substances that act to reduce the natural melting temperature of the nutritional supplement. For example, medium chain tryglycerides and/or sunflower oil may be provided within the composition to act to reduce the melting point of the nutritional supplement, particularly oil-based nutritional supplements, which otherwise would be waxy or solid at normal usage temperature at least in the range of 10° C. to 25° C. approximately.

The nutritional supplement may comprise one or more water insoluble or partially soluble solids, instead of or in addition to the aforesaid oil and oil-based supplement. Such solid(s) may include one or more of minerals, salts, oxides, including those containing calcium compounds and/or magnesium compounds such as calcium phosphate, di-calcium phosphate, calcium sulphate and calcium carbonate (usually in non-acidic media), dolomite, ancient corals, ancient marine creatures, skeletal deposit sediments, bone and/or other similar minerals and salts. The solids may be finely divided in powder or other small particulate form.

Such solid nutritional supplements may be retained in and by the fibrous matrix of the matter. This has a number of advantages. Such solids would normally tend to gravitate downwards or precipitate within a liquid medium, but the retention within the fruit and/or vegetable matter helps to prevent such gravitation or precipitation. This provides the compositions of the invention with relatively good storage properties and long shelf life. The presence of the solids is generally masked by the fibrous matrix. It is also the case that such solid nutritional supplements tend to have few or less pungent generally considered adverse flavour characteristics than some soluble counterparts, offering less potential for their presence to detract from the attractiveness of the composition for consumption. Such solid forms are also typically cheaper and/or more practically usable than their soluble counterparts, have generally better storage characteristics and have generally better stablility against undesirable deterioration.

Such solid nutritional supplements could typically comprise between 0.05% and 5.0% by weight of the composition. The solid nutritional supplements may comprise between 0.01% and 3.90% by weight of the composition. In certain embodiments the solid nutritional supplement may comprise between 0.4% and 3% by weight of the composition, and in others between 0.05% and 1% by weight and others between 0.1% and 0.5% by weight.

The nutritional supplement may be present on or in a carrier substrate, which may be water soluble or water dispersible and may comprise one or more of vegetable gum, acacia gum, gelatine, gum arabic, methyl cellulose gum, soluble cellulose, starch, sugar, glucose, maltodextrin, dextrin, casein, milk powder, skimmed milk powder, soya milk, soya milk powder, soya protein, plant protein, legume seed protein and the like. The carrier may be soluble in the base.

A thickening and/or stabilising agent may be used to increase the viscosity of the base and to give the product the desired texture. This has the advantage of further hindering movement of the nutritional supplement retained by the fibrous matrix.

Additional edible fibre and/or hydrocolloid, in particular plant derived fibre and hydrocolloid, can be used to provide stabilisation and/or thickening of the composition to give the product the desired texture. Divalent anion soluble salts such as calcium chloride, magnesium sulphate and calcium gluconate can be added to help cross-link certain hydrocolloids such as some pectins in the composition to increase the thickening and/or gelling properties.

The composition may comprise a sauce such as a ketchup, table sauce, cooking sauce, condiment sauce, relish, dressing, soup or other generally liquid or semi-liquid edible foodstuff such as chutneys, purees, beverages, concentrates like concentrated soup, fruit and/or vegetable paste, spreads.

Alternatively, the composition may comprise a generally non-liquid foodstuff, such as a paste, preserve, jam, conserve, spread, chutney sauces.

According to a second aspect of the present invention, there is provided a method of manufacturing an edible composition, the method comprising dispersing a water immiscible nutritional supplement in a base comprising fruit and/or vegetable matter with a fibrous matrix to retain the water immiscible nutritional supplement within the structure of the fibrous matrix.

The nutritional supplement may be dispersed, such as by mixing, within the base, preferably to be generally evenly distributed throughout, preferably using a mechanical mixer such as a turbine-type motorised mixer, like a Silverson mixer, rotating blade(s) mixers, whisks, pressure/jet mixers, in-line or pipeline connected mixers, other suitable mixing devices including both mechanised and manually/hand operated devices.

The base may comprise most if not all of the desired ingredients of the composition, other than the nutritional supplement. The nutritional supplement may be gently mixed into the base to prevent the droplet size of oily supplement from becoming so small as to impart an undesirable visual appearance to the composition, such as a milky, turbid or cloudy appearance to the composition. Alternatively, the nutritional supplement can be mixed into the base at relatively high speeds for a relatively short period of time. Such appearances are found to detract from the attractiveness of the composition to a typical consumer, particularly where the concentration of insoluble oily matter is relatively high (above 0.5%), particularly for products that the typical consumer would normally associate with fruits and/or vegetables and which therefore they would not ordinarily expect to have a cloudy or milky appearance, such as tomato ketchup and brown sauce. Preferably the nutritional supplement is dispersed within the composition to form droplets, the vast majority of droplets having a diameter of less than 30 microns, and preferably most (between approximately 85% and 90%) having a droplet size of between 5 and 10 microns.

Any added thickeners and/or stabilisers may be mixed in the base prior to dispersion of the nutritional supplement to the base.

The nutritional supplement may be introduced to the base in the form of an oil-and-water emulsion, which may comprise an emulsifier. The oil of the emulsion may consist wholly or substantially wholly of the nutritional oil of the supplement, or in alternative embodiments further oil may be provided. In embodiments where the nutritional supplement is not oil or oil-based, the oil of the emulsion may comprise a carrier oil such as one or more plant and/or animal derived oils.

The nutritional supplement may be introduced to the base in alcohol, polyol or in an alcohol-based solution.

The nutritional supplement may be introduced to the base in the form of one or more saponified nutritional oil or oils. Such saponified oil(s) may be produced by reacting the oil or fatty acid(s) within the oil with an alkaline substance, such as potassium hydroxide and/or potassium carbonate. When the saponified oil is then mixed with acidity within the composition, the saponification is reversed to release the nutritional oil fatty acids. Introducing the nutritional oil in saponified form helps to integrate the oil into the wholly or predominantly aqueous base.

The or one or more of the nutritional oils in the nutritional supplement may be in the form of fatty acids, typically the nutritionally functional component of the oil(s).

The nutritional supplement may be presented on or in a carrier substrate, such as on or in particles, flakes or granules of gelatine, soya, plant protein, legume seed protein, casein, milk powder, skimmed milk powder, soya milk, soya milk powder, soya protein, vegetable gum, acacia gum, gum arabic, dextrin, methyl cellulose gum, soluble cellulose, starch, sugar, glucose, maltodextrin and suchlike, that is preferably generally soluble within the base. The nutritional supplement may be presented on a carrier such as caseine, which may be in the form of fine particles and which are not soluble in the base when precoagulated by acidification, for example.

The nutritional supplement may be added to the base as an admix or premix of supplement and carrier substrate as a solution, suspension (such as a suspension of fine powder acidulated caseine encapsulated nutritional oil) and/or as an emulsion (such as an emulsion of nutritional oil or diluted nutritional oil emulsified in an aqueous medium).

The method may involve the use of a base as described above.

The method may substantially involve the use of a nutritional supplement as described above.

The method may involve a step to remove dissolved and/or entrapped air within the composition. This helps to preserve oil(s) within the composition against undesirable oxidation, mitigate against the development of cloudiness of the composition and potential disturbance of oil droplets and/or retained supplement particles by the air gradually tending to ascend to the surface of the base. Such a step may involve heating, vacuum treatment and/or flushing with generally oxygen-free and/or oxygen depleted gas and/or steam.

Embodiments of the present invention will now be described by way of example only.

There are provided edible compositions and methods of manufacturing edible compositions, in particular compositions based on pulpy fruit and/or vegetable matter.

The edible compositions comprise a base comprising fruit and/or vegetable matter with a fibrous matrix and a water immiscible nutritional supplement held within, including on the surfaces of the fibrous matrix.

The edible compositions of the present invention are typically comprised of one or more fruits and/or vegetables and although the compositions are typically liquid or semi-liquid, they can be generally non-liquid. Examples of liquid and semi-liquid edible compositions of the present invention are tomato sauces, tomato ketchups, other condiment or table sauces such as brown sauce, steak sauce, fruit and/or vegetable based cooking sauces, relishes, dressings, chutneys, chutney sauces, concentrates, pastes, spreads, conserves and the like, soups and beverages. Examples of generally non-liquid compositions according to the present invention include fruit/vegetable pastes, preserves, jams, conserves, purees.

The types and varieties of fruits and vegetables that can be used in the compositions of the present invention are preferably those that have a sufficiently fibrous/pulpy composition to provide the fibrous matrix, such as tomatoes, apples, plums, mangoes, pumpkins, pomegranate, beetroot, grapes, peaches, apricots, dates, potato, wheat, rice, cereals, banana, strawberry, raspberry, celery, carrots and many others. They can be used either in the natural state or treated or preserved such as dried or cooked. It is the natural fibrous matter found in the fruits and or vegetables that provide the important fibrous matrix for the present invention. Although the precise composition of the fibrous matrix will be determined by the fruits and/or vegetables used in a particular composition, and to some extent the way those fruits and/or vegetables are processed, the fibrous matrix of the compositions typically comprise both soluble and insoluble dietary fibre. The insoluble fibre typically comprises primarily cellulose and can comprise hemicellulose and/or lignins. The soluble fibre typically comprises pectin and can comprise gum and/or other non-starch polysaccharides and oligosaccharides. Both the insoluble and soluble fibres in the fibrous matrix contribute to the retention of the nutritional supplement. The soluble fibres are understood to act as soft gels or thyxotropes that act to resist movement of the nutritional supplement, facilitating entrapment and retention of the supplements within the base.

Typically, all or most associated skin, cores, seeds and suchlike would be removed before pulping, although it will be appreciated that the extent these need or are desired to be removed can depend upon the fruit/vegetable concerned and the product being made.

The type and variety of fruit and/or vegetable used for a particular composition will be chosen according to the nature of the composition to be produced. For example, to produce a tomato sauce or tomato ketchup, the fruits used would be predominantly tomatoes, although of course additional fruits and/or vegetables as well as further ingredients would typically be incorporated to achieve the desired composition.

The base is formed by processing the fruit and/or vegetables to such an extent as to provide a pulpy fibrous matrix to hold the nutritional supplement, as will be explained. The fruits and/or vegetables may be pulped, comminuted, shredded, blended, mushed, mashed, crushed, grated or otherwise reduced to form a base which, as said before, would typically be liquid or semi-liquid, or could be substantially non-liquid. Typically, fruits and vegetables contain significant amounts of water, although the actual amount as a percentage of weight varies between types and varieties and can vary within varieties. This is particularly so for fruits/vegetables in their natural state. However, typically, when pulped, they become generally liquid or semi-liquid if the amount of water is sufficient. The water inherent or naturally present within the fruits and/or vegetables typically provides the aqueous properties of the base, although further water or water-based liquids such as vinegar, stock, salt solution, sugar solution, sweetened solutions and the like can be added if required. When dried fruit/vegetables are used, for example, the amount of water present within the dried fruit/vegetable may need to be supplemented with added water to provide the desired consistency and aqueous presence. In other embodiments the amount of inherent or naturally occurring water in the fruits/vegetables may need to be reduced to provide the base with the desired overall viscosity. Conventional processes such as evaporation and evaporation with vacuum, concentration by cooking, boiling, boiling under reduced pressure conditions, or any other suitable process or method can be used.

Additional edible fibre and/or hydrocolloid, in particular plant derived fibre and hydrocolloid, can be used to provide stabilisation and/or thickening of the composition to give the product the desired texture. Divalent anion soluble salts such as calcium chloride, magnesium sulphate and calcium gluconate can be added to help cross-link certain hydrocolloids such as some pectins in the composition to increase the thickening and/or gelling properties.

Due to the aqueous nature of the base of certain embodiments of the present invention, the addition of a water immiscible nutritional supplement would be expected to present difficulties of separation between the base and the nutritional supplement, but the present invention cleverly uses the fibrous matrix of the fruit/vegetable matter to help prevent separation and to retain the water immiscible nutritional supplement in a dispersed condition within the base, by holding the water immiscible nutritional supplement within the fibrous matrix. The nutritional supplement is generally physically retained by the architecture of the fibrous matrix, being typically entrapped within the mesh or network of fibres that make up the architecture of the fibrous matrix. This retention hinders the movement of the nutritional supplement, thus hindering the natural tendency to separate. The level of fibre from the fruit/vegetable pulp therefore needs to be sufficiently high for these beneficial effects to be appreciated and it has been found that the base would typically comprise more than 0.5 g of fibrous matrix per 100 g of base. In certain embodiments the base would comprise more than 3 g of fibre matrix per 100 g of base and in others between 3 g and 5 g per 100 g. In particular embodiments the base would comprise between 0.15 g and 2.5 g of fibre matrix per 100 g of base and in others between 0.4 g and 1.7 g of fibre matrix per 100 g of base. In certain embodiments the amount of fibrous matrix may comprise the total fibre content in the base.

The fibre content can be determined by the AOAC (2000) enzymatic gravimetric method (Prosky (985-29)), or any other suitable analytical method.

In preferred embodiments the compositions comprise oil or oil-based nutritional supplements. The nutritional supplement can be oil soluble and/or oil solublisable. The invention also provides for water insoluble, partly soluble and/or poorly soluble nutritional supplements that can be considered to be immiscible or only partially immiscible in water.

For oil or oil-based nutritional supplements, droplets of the nutritional supplement are physically retained in the fibrous matrix of the fruit/vegetable matter. As indicated previously, it enables the generally immiscible nutritional supplement to be retained within the composition with relatively little movement of the supplement, thus preventing or at least significantly hindering separation and the natural tendency for the nutritional supplement to float to the surface or sink toward the bottom of the base. This provides the composition with good storage properties and shelf life. This also helps to prevent the need for the oil droplets to be reduced to such a small size that a milky or cloudy or other undesirable discolouration of the composition is introduced as the oil droplets act to deflect light to such an extent to introduce such an effect, which are generally considered unattractive to consumers, particularly where the consumer has a preconceived concept of how a product should appear. For example, a consumer typically expects a tomato ketchup to have a deep red, fairly translucent tomato colour and not to have any milky, cloudy or possibly pinkish discolouration or any oil floating at or near the top or sedimented at or near the bottom of the container. In the compositions of the present invention nearly all (99%) of droplets dispersed in the composition have a diameter of less than 30 microns, with between 85% and 90% having a diameter of between 5 and 10 microns.

A further advantage of the present invention is that the presence of the nutritional supplement within the composition is masked in the sense of its presence being disguised, thus helping to mask any unattractive qualities of the nutritional supplement, such as adverse taste, visual and/or smell qualities.

In particular embodiments the nutritional supplement comprises one or more oils or oily substances, such as unsaturated and partly unsaturated fatty acids including polyunsaturated fatty acids, Omega 3 fatty acids including ALA (alpha linoleic acid) and DHA (docosahexaenoic acid), gamma, linoleic acid (long and/or short chain), conjugated linoleic acid, phytosterols, phytostanols, including such substances isolated or carried in an oil, in particular their natural source oil such as fish oil, linseed oil, walnut oil, starflower oil, evening primrose oil, safflower oil.

Such oils have well documented health and nutritional benefits. Omega 3 fatty acids in fish oil and gamma linoleic acid contained in starflower oil seed for example cannot be produced by the human body and so introducing them into the diet as a nutritional supplement is generally beneficial. Typical sources of long chain Omega 3 fatty acids such as ALA include fish oils, krill oils and algae oils, including fermented algal oils. Typically, such marine-derived oils have a taste and odour that would not typically be considered complementary to a traditional fruit/vegetable based product, but when added in relatively small amounts, the inherent taste/odour may be adequately masked by the base. Safflower oil, linseed, flax, hemp, rapeseed and sesame oils are examples of sources of short chain Omega 3 oils and rich plant derived oils, which would preferably be refined, deflavourised and deodorised. Other oils that can be comprised in the nutritional supplement are canola oil, pumpkin seed oil, wheatgerm oil, rice germ oil, borage seed oil, blackcurrant seed oil, evening primrose seed oil. Where the nutritional supplement has perceptible undesirable properties such as undesirable taste/odour properties, they can be refined, deflavourised and/or deodorised to a satisfactory level to remove or satisfactorily reduce the undesirable effect. Different oils can be blended or used together to help address any undesirable taste, smell or other properties that may put a potential consumer off consuming the composition. For example, fish or micro-algal oils rich in Omega 3 fatty acids tend to have “fishy” taste and smell characteristics and so to reduce the impact of these characteristics such oils can be diluted or complemented with one or more Omega 3 rich oils that do not exhibit such taste and smell characteristics, such as Omega 3 fatty acid rich seed oils like those of rapeseed, canola and others, to bring the overall taste and smell characteristics of the finished product to an acceptable level. The nutritional supplement can also be treated to remove known allergens, such as for example, EPA (eicosapentaenoic acid)/DHA (docosahexaenoic acid) containing fish oil can contain one or more fish (protein) allergen and in compositions of the present invention the oil is so highly refined and distilled that the fish protein allergen is no longer detectable or otherwise at an acceptable allergen level.

Seed oils may also be used as a source of nutritional supplement, such as linseed oil, flax oil, hemp oil, rapeseed and sesame oil, and as indicated above would preferably be refined and/or deodorised before use.

In certain embodiments the nutritional supplement could comprise one or more of other oil-like substances such as phytosterols, phytostanols, oil soluble and oil solublisable minerals and organomineral supplements, organometal supplements, conjugated linoleic acids, lutein, licopene, probiotics such as inulin and others, either alone or in addition to other substances disclosed herein.

The composition may comprise further components such as one or more of additional water, antioxidants including rosemary extract, Vitamin E (tocopherol), ascorbyl palmitate, BHA, BHT and BHQ, ascorbic acid and/or its salts (amongst others), preservatives, flavourings, colourants, sweeteners, acidity regulators, thickeners, stabilisers, chelating agent, Vitamin C, gelling agents, agar-agar, carrageenan, alginate, pectin, calcium and/or magnesium salts, vinegars, salt, sugar (raw, refined and/or partly refined), fructose, fructose syrup, inulin, oligofructose, molasses, fruit juice concentrates, polysaccharides, glucose, dairy products such as skimmed or partly skimmed milk, whey, buttermilk, yoghurt, soya and soya products such as soya protein, soya milk and suchlike. Such further components may be used in their natural state and/or in modified or derivative form.

Typically, the oil or oil-based nutritional supplement comprises between 0.005% and 5% by weight of the composition. In particular embodiments, such nutritional supplement comprises between 0.01% and 5% and in others between 0.1% and 3% by weight of the composition. For example, where the nutritional supplement comprises oils that are naturally relatively low in the relevant nutrient, nutraceutical, etc, such as seed oils like rapeseed and flax oils that are relatively low in the nutrient DHA (docosahexaenoic acid) up to 5%, such as 1% to 5% of supplement may be present. In other more nutrient/nutraceutical rich supplements such as fish oil and micro-algae oil, which are relatively rich in DHA, the supplement may comprise 0.05% to 1% by weight of the composition in certain embodiments and between 0.1% and 0.5% in others.

In certain embodiments the nutritional supplement may comprise substances from a number of different sources to provide a blend of nutritional substances. Further, the source of the supplements can be selected according to desired odour and/or taste characteristics of the edible composition. For example, nutritional oils derived from aquatic or marine sources tend to have a marine or fishy taste and smell which can be considered undesirable, deterring a potential consumer from ingesting the composition. To help reduce the level of such taste and odour characteristics, nutritional substances from such sources (and other sources that exhibit undesirable organoleptic properties) can be complemented with one or more substances from other sources that are not generally considered to exhibit such undesirable taste and/or smell characteristics, thus enabling the amount of the aquatic or marine (etc) sourced substances to be reduced to a more acceptable level. In certain embodiments seed oils such as that of rapeseed is used alongside fish and/or algal oils to help dilute the “fishy” taste and smell of the latter. Examples are set out hereinafter.

The nutritional supplement may be introduced into the base carried in or on a carrier. The nutritional supplement may be enclosed within a capsule which would typically be water soluble, but could be water dispersible, thus releasing the nutritional supplement once mixed within the aqueous base. The capsule would typically comprise one or more of gum such as acacia gum and arabic gum, methyl cellulose gum, dextrin, gelatine, caseine, milk powder, skimmed milk powder, soya protein, plant protein, legume seed protein. Alternatively, or in addition, the nutritional supplement is carried on a granular, flake or particulate carrier, which is again preferably soluble in the base, and could be one or more of a gum such as acacia gum, gum arabic, dextrin, methyl cellulose gum, gelatine, soya, plant protein, legume seed protein, soya milk, soya milk powder, soya protein, casein, vegetable gum, cellulose, starch, sugar, glucose, maltodextrin.

In certain embodiments the or some of the nutritional supplement can be introduced into the base as one or more saponified oils. Such saponified oils can be produced by reacting the oil or the fatty acid(s) within the oil with an alkaline substance such as potassium hydroxide and/or potassium carbonate. The saponified oil is mixed into the base and the soapy nature helps the mixing of the oil within the typically aqueous base. As the oil is mixed into the base, the typically acidic base reacts to release the fatty acids from the saponified oil and thus realise a good intermixing of the nutritional oil within the base.

In certain embodiments the or one of the nutritional oils in the supplement are provided as fatty acids, typically the nutritionally functional component on the oil(s).

In alternative embodiments of the present invention, the immiscible nutritional supplement comprises water insoluble or partially soluble solids, either instead of or in addition to the aforesaid oil and oil-based supplements. Such solids can include minerals, salts, oxides including calcium and/or magnesium salts such as calcium phosphate, di-calcium phosphate, calcium carbonate and calcium sulphate. Minerals such as dolomite and those derived from bones, ancient corals, ancient marine creatures and skeletal deposits can be used. The solids would typically be in fine powder form or another finely divided particulate of sufficiently small size so as not to be detectable during consumption of the composition by way of presenting a powdery or gritty consistency or effect in the mouth of a consumer.

The solid nutritional supplement would be retained or held in the fibrous matrix of the fruit/vegetable matter, which helps to mask the presence of the solid particulates. This also helps to prevent movement of the solids, such as by way of the natural tendency to settle within a liquid medium, thus offering the compositions relatively good storage properties and long shelf lives.

The ability to incorporate insoluble or poorly soluble nutritional supplements such as the aforesaid calcium phosphate and calcium sulphate is advantageous in that not only do they impart additional nutritional and/or health benefits, but they typically exhibit flavour characteristics that are generally considered less unpalatable or adverse than their soluble counterparts, thereby offering less potential for their presence to be noted and to detract from the traditional flavour and attractiveness of the composition for consumption. Such insoluble forms are also typically cheaper than their soluble counterparts and generally have better and more convenient storage properties and are generally more stable against undesirable deterioration.

Such solid nutritional supplements would typically comprise between 0.05% and 5.0% by weight of the composition. The solid nutritional supplements could, in particular embodiments, comprise between 0.4% and 3% by weight of the composition and in others between 0.05% and 1% and in others between 0.1% and 0.5% by weight of the composition.

The following are specific examples of compositions according to the present invention.

### EXAMPLE 1

### Tomato Ketchup with Refined and Deodorised Fish Oil

| Ingredient | Amount (% by weight) |
|---|---|
| Tomato puree | 26.00 |
| (tomato paste double | |
| concentrated) | |
| Spirit vinegar | 8.00 |
| Sugar | 20.00 |
| Salt | 4.95 |
| Seasonings and spices | 0.60% |
| Water | 41.01 |
| Fish oil | 0.05% |
| (refined and deodorised) | |

### EXAMPLE 2

### Tomato Ketchup with Fish Oil

| Ingredient | Amount (% by weight) |
|---|---|
| Tomato puree | 25.00 |
| (tomato paste double | |
| concentrated) | |
| Spirit vinegar | 8.00 |
| Sugar | 20.00 |
| Salt | 3.10 |
| Seasonings and spices | 0.58 |
| Cooking starch | 1.75 |
| Water | 41.17 |
| Fish oil | 0.40 |

The cooking starch would usually be physically and/or chemically modified starch and can be partly or entirely replaced in appropriate quantities by food grade hydrocolloids, embracing thickeners and/or stabilisers, such as but not only xanthan gum, gum tragacanth, guar gum, acacia gum, alginates, carrageenans, compounds and/or derivatives of any of these and reactants such as calcium salts.

### EXAMPLE 3

### Brown Sauce with Fish Oil

| Ingredient | Amount (% by weight) |
|---|---|
| Water | 28.06 |
| Tomato puree | 7.84 |
| Apple juice concentrate | 1.95 |
| Cane molasses 78% | 9.00 |
| Caramel (colour) | 0.17 |
| Apple puree | 19.64 |
| Cooking starch | 2.50 |
| Seasonings and spices | 1.34 |
| Sugar | 9.00 |
| Malt vinegar | 18.00 |
| Refined deodorised | 0.40 |
| fish oil | |

The fish oil can be replaced in whole or in part by algal oil, particularly refined deodorised algal oil (typically rich in Omega 3 fatty acids (DHA type)).

### EXAMPLE 4

### Brown Sauce and Fish Oil

| Ingredient | Amount (% by weight) |
|---|---|
| Water | 23.00 |
| Tomato puree | 13.80 |
| Apple juice concentrate | 1.95 |
| Cane molasses 78% | 9.00 |
| Caramel (colour) | 0.17 |
| Apple puree | 22.14 |
| Seasonings and spices | 1.34 |
| Sugar | 9.00 |
| Malt vinegar | 18.00 |
| Fish oil | 0.04 |
| (refined and deodorised) | |

The fish oil can be replaced in whole or in part by algal oil, particularly refined deodorised algal oil (typically rich in DHA).

In these examples, almost all (about 90%) of the fish oil nutritional supplement was present in droplets less than 30 microns, with 85% to 90% of the droplets being between 5 and 10 microns in diameter.

### EXAMPLE 5

### Tomato Ketchup with Flax Oil and Sweetener

| Ingredient | Amount (% by weight) |
|---|---|
| Tomato puree | 30 |
| Spirit vinegar | 10 |
| Sugar | 9.2 |
| Salt | 3.1 |
| Sweetener (aspartame) | 0.02 |
| Seasonings and spices | 0.6 |
| Water | 46.08 |
| Flax oil | 1 |

The flax oil can be replaced wholly or partly by one or more other nutritional oils such as algal oil, borage oil, rapeseed oil, canola oil.

### EXAMPLE 6

### Tomato Ketchup with CLA (Tonalin) and Fish Oil

| Ingredient | Amount (% by weight) |
|---|---|
| Tomato puree | 25 |
| Spirit vinegar | 9 |
| Sugar | 20 |
| Salt | 4 |
| Seasonings and spices | 0.6 |
| Water | 39.7 |
| Deodorised fish oil | 0.2 |
| Tonalin (CLA) | 1.5 |

CLA = conjugated linoleic acid

Calcium or other non-oil nutritional supplements can be added and the equivalent amount of water deducted from the added water content.

### EXAMPLE 7

### Tomato Ketchup with Micro-Algal Oil and Seed Oil

| Ingredient | Amount (% by weight) |
|---|---|
| Tomato puree | 22.00 |
| Spirit vinegar (12%) | 9.00 |
| Sugar | 21.00 |
| Salt | 2.10 |
| Chilli powder | 0.02 |
| Garlic powder | 0.01 |
| Modified starch | 2.77 |
| (thickener) | |
| Water | 43.06 |
| Micro-algal oil | 0.01 |
| Rapeseed oil | 0.02 |

### EXAMPLE 8

### Tomato Ketchup with Fish Oil and Seed Oil

| Ingredient | Amount (% by weight) |
|---|---|
| Tomato puree | 22.00 |
| Spirit vinegar 12% | 9.00 |
| Sugar | 21.00 |
| Salt | 2.10 |
| Chilli powder | 0.02 |
| Garlic powder | 0.01 |
| Modified starch | 2.77 |
| (thickener) | |
| Water | 43.06 |
| Fish oil | 0.01 |
| Rapeseed oil | 0.02 |

In Examples 7 and 8, the micro-algal and fish oil as sources of Omega 3 fatty acids are complemented by the presence of rapeseed oil, as another source of Omega 3 fatty acids. Micro-algal and fish oils are typically rich in DHA Omega 3 fatty acids. Seed oils such as rapeseed oil are typically rich in EPA Omega 3 fatty acids. The combined use of these Omega 3 fatty acid rich oils gives the product the desired level and composition of nutritional supplement whilst keeping the amount of micro-algal and fish oil to a level at which the typically “fishy” taste and smell characteristics of these oils are not generally detectable by an average consumer.

As indicated hereinbefore, any suitable combination or blend of nutritional oils can be used to achieve the desired nutritional or nutraceutical content in the product along with other desired properties or characteristics of the product such as taste, smell, appearance and the like. By way of example, phytosterol rich oils, such as tall oil, can be used alongside Omega 3 fatty acid rich oils, again where desired to dilute or reduce the presence of oils that have undesirable side-characteristics such as a fishy taste and/or smell.

The present invention also provides a method of manufacturing an edible composition, the method comprising dispersing a water immiscible nutritional supplement in a base comprising fruit and/or vegetable matter with a fibrous matrix to retain the nutritional supplement within the structure of the fibrous matrix.

It has been found that such compositions can benefit from being manufactured with most if not all of the ingredients of the composition provided in the base, to which the nutritional supplement is then added. This can have advantage where the nutritional supplement is added as a liquid, and particularly as a liquid comprising oil. Ideally, the oil droplet size in the composition is no smaller than 5 microns and preferably the droplet size is predominantly in the range of 5 to 30 microns, although in certain embodiments between about 70% and 90% of the nutritional supplement is present in droplet sizes of between 5 and 10 microns. This helps to mitigate against the introduction of a milky or other undesirable visual effect to the composition as a result of the oil droplets becoming sufficiently small that they start to scatter incidental light.

A mechanised mixer such as a turbine-type motorised mixer like a Silverson mixer has been found suitable to mix the various components together to produce compositions of the present invention. Other suitable mixers can be used, such as rotating blade(s) mixers, whisks, pressure jet mixers, in-line or pipeline connected mixers. Manually/hand operated devices can be used, particularly when relatively small amounts of composition are to be made.

This advantage is particularly seen where the base is relatively viscous, such as where thickeners or stabilisers are provided, as may be the case for example in tomato ketchup and similar such sauces.

Adding thickeners and stabilisers is generally advantageous, as they can work with the fibrous matrix to hinder the movement of the nutritional supplement within the base and thus help with the stability and shelf life of the product.

Additional edible fibre and/or hydrocolloid, in particular plant derived fibre and hydrocolloid, can be used to provide stabilisation and/or thickening of the composition to give the product the desired texture. Divalent anion soluble salts such as calcium chloride, magnesium sulphate and calcium gluconate can be added to help cross-link certain hydrocolloids such as some pectins in the composition to increase the thickening and/or gelling properties.

In certain embodiments the nutritional supplement is introduced to the base in the form of an oil-and-water emulsion, which would optionally be stabilised with one or more emulsifiers. The or each emulsifier would generally be chosen from known emulsifiers for foodstuff usage, and would be selected to requirements by the person skilled in the art.

The oil of the emulsion can in certain embodiments consist of the whole or substantially the whole of the nutritional oil of the supplement. In alternative embodiments the oil of the emulsion consists of nutritional oil plus a further oil, such as one or more plant and/or animal (including fish and algae) derived oils.

In embodiments where the nutritional supplement is not oil or oil-based, the oil of the emulsion can comprise a carrier oil such as one or more plant and/or animal (including fish and algae, including microalgal) derived oils.

In certain embodiments the nutritional supplement may be introduced to the base in alcohol or in an alcohol-based solution. The alcohol or alcohol-based solution can comprise any suitable food grade alcohol(s), including ethyl alcohol, propanol, iso-propanol, glycerol, ethyl glycol, polyol and others in their natural, modified, and/or synthetic form.

In certain embodiments the fruit and/or vegetable to be used in the base is enzyme deactivated, such as by heat treatment. This can help to prevent or hinder undesirable degradation of the fruit/vegetables during storage and/or manufacture of the composition and moreover, certain fruits/vegetables such as tomatoes generally develop better more desirable textures, giving a thicker product that may not require the addition of thickeners or stabilisers, whilst still offering the composition a traditional texture and mouth feel for a tomato sauce. Where the composition is manufactured using prepared pulp materials such as tomato concentrate, tomato paste and/or tomato puree, these are preferably heat treated to facilitate storage.

As indicated previously, the nutritional supplement can be introduced on or in a carrier, such as within a capsule and/or on or in a particulate or granular carrier that is soluble within the base. Such carriers may comprise gelatine, gums, such as acacia gum, gum arabic, methyl cellulose gum, dextrin, soluble cellulose, starch, sugar, glucose, maltodextrin, milk or milk protein (casein), soya protein, plant protein or suchlike.

The nutritional supplement may be added to the base as an admix or premix of supplement and carrier substrate as a solution, suspension (such as a suspension of fine powder acidulated caseine encapsulated nutritional oil) and/or as an emulsion (such as an emulsion of nutritional oil or diluted nutritional oil emulsified in an aqueous medium).

Introducing the nutritional supplement on a carrier or encapsulated can further help to reduce the apparent presence of the supplement within the composition. For nutritional supplements that typically have an odour and/or taste, such as fish oil or supplements derived from fish oil, algal oil and/or Omega 3 rich plant derived oils such as flax oil or other nutritional oils such as borage oil, blackcurrant oil, masking the inherent odour and/or taste in this way can be beneficial.

As indicated previously, the nutritional oil can be added in saponified form or as the functional fatty acid component of the oil.

For particular nutritional supplements, such as Omega 3 rich oil, they are believed to oxidise rapidly upon contact with air/oxygen and the compositions of the present invention can benefit from the addition of antioxidants to help to offset or counteract such oxidative properties. Antioxidants could include Vitamin E (tocopherol), ascorbyl palmitate, BHA, BHT, BHQ, ascorbic acid and/or its compounds, ascorbic palmitate and others as generally used in the manufacture of foodstuffs.

The method of manufacture may also involve treatment of the composition to remove dissolved oxygen in the composition, to help minimise the oxidative effect of this and thus help to prevent undesirable deterioration of the composition, in particular the oils therein. This may also help prevent the development of a cloudy appearance to the product and potential disturbance of the nutritional supplement by the air gradually tending to ascend to the surface of the base taking the nutritional supplement, particularly oily supplements, with it. Such treatment may include heating, vacuum treatment and/or flushing with a suitable gas and/or often less desirably steam.

The method may also involve the addition of one or more substances that act to lower the temperature at which the nutraceutical oils start to solidify or partially solidify in the composition. This would be particularly useful for oils which tend to solidify or partially solidify at temperatures in the range 0° C. to 30° C., such as concentrated conjugated linoleic acids. Such additive substances could include medium chain triglycerides (for example a fraction from palm oil), sunflower oil and other oils usually liquid at temperatures at least in the range 7° C. to 50° C.

In certain embodiments the compositions of the present invention can be manufactured to be relatively low in sugars and sodium perhaps by replacing any added sugars and/or salt with sweetener and/or salt substitutes such as potassium chloride. Taste improvers, bitterness inhibitors and/or acidity inhibitors may be used.

It will be appreciated that within the context of the present invention, the nutritional supplement can be used in any appropriate form, including its natural state, in modified form and indeed analogues can be used, and these can be used singly or in combination.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An edible composition comprising tomato ketchup, the edible composition having a base comprising fruit and/or vegetable matter, a fibrous matrix, and a water immiscible nutritional supplement held within the fibrous matrix, the nutritional supplement comprising an oil, the oil being rich in Omega 3 fatty acids, wherein the nutritional supplement is in the form of droplets, the majority of which have an external diameter of less than 30 microns.

2. An edible composition as claimed in claim 1, in which the fibrous matrix is plant-derived.

3-7. (canceled)

8. An edible composition as claimed in claim 1, in which the base is aqueous.

9. An edible composition as claimed in claim 1, in which the base comprises matter suspended in an aqueous liquid.

10. (canceled)

11. An edible composition as claimed in claim 9, in which the aqueous liquid comprises a juice of one or more different fruit(s) and/or vegetable(s).

12. An edible composition as claimed in claim 1, in which the matter comprises one or more of pulped, comminuted, mashed, blended, crushed, mushed, shredded, natural state, cored, de-seeded, pre-pureed and/or grated fruit(s) and/or vegetable(s).

13. An edible composition as claimed in claim 9, in which the base comprises pulp of one or more fruit(s) and/or vegetables suspended in the aqueous liquid.

14-15. (canceled)

16. An edible composition as claimed in claim 1, in which one or more of the fruits/vegetables is heat treated to reduce or deactivate enzyme activity.

17. An edible composition as claimed in claim 1, in which the base comprises additives.

18-23. (canceled)

24. An edible composition as claimed in claim 1, in which the composition is liquid or semi-liquid.

25. (canceled)

26. An edible composition as claimed in claim 1, in which the nutritional supplement comprises one or more of a nutritional, functional and/or nutraceutical oil, or one or more of oils, oily substances containing nutritional, functional and/or nutraceutical agents and unsaturated or partly unsaturated fatty acids.

27-41. (canceled)

42. An edible composition as claimed in claim 1, in which the composition comprises one or more substances that act to reduce the natural melting temperature of the nutritional supplement, which otherwise would be waxy or solid at normal usage temperature at least in the range of 10° C. to 25° C. approximately.

43-52. (canceled)

53. An edible composition as claimed in claim 1, in which the nutritional supplement is present on or in a carrier substrate, which carrier substrate is water soluble or water dispersible.

54-60. (canceled)

61. A method of manufacturing an edible composition comprising tomato ketchup, the method comprising dispersing a water immiscible nutritional supplement comprising an oil, the oil being rich in Omega 3 fatty acids, in a base comprising fruit and/or vegetable matter with a fibrous matrix to retain the water immiscible nutritional supplement within the structure of the fibrous matrix, wherein the nutritional supplement is dispersed within the composition to form droplets, the vast majority of droplets having a diameter of less than 30 microns.

62-64. (canceled)

65. A method as claimed in claim 61, in which thickener and/or stabiliser is mixed in the base prior to dispersion of the nutritional supplement to the base.

66-81. (canceled)

82. An edible composition as claimed in claim 2, the fibrous matrix comprising natural insoluble fibres from fruit and/or vegetables, or one or more of primarily cellulose, hemicelluloses, lignin, soluble fibres, pectin, gum, non-starch polysaccharides and oligosaccharides.

83. An edible composition as claimed in claim 17, said additives comprising one or more of water, antioxidants, preservatives, flavourings, seasonings, colourants, sweeteners, acidity regulators, thickeners, stabilisers, chelating agent, vitamins, Vitamin C, vinegars, acidity regulators, salt, raw, refined and/or partly refined sugar, fructose, fructose syrup, inulin, oligofructose, polysaccharides, glucose, molasses and fruit juice concentrates.

84. An edible composition as in claim 83, said antioxidants being selected from the group consisting of Vitamin E (tocopherol), ascorbyl palmitate, BHA, BHT, BHQ, ascorbic acid and its salts.

85. An edible composition as claimed in claim 1, said nutritional supplement comprising one or more of polyunsaturated fatty acids, conjugated linoleic acid (CLA) and its isomers, partly saturated fatty acids, fatty acid esters, oils and/or oily substances derived from one or more of plant sources, animal sources and other organism sources, L-carnitine, phytosterols including their esters, phytostanols including their esters, mineral supplements, organomineral supplements, organometal supplements, antioxidants and suchlike.

86. An edible composition as claimed in claim 42, said one or more substances that act to reduce the natural melting temperature of the nutritional supplement comprising one or more of medium chain triglycerides and sunflower oil.
